(19) United States
(12) Patent Application Publication
(10) Pub. No.: US 2013/0268388 A1
(43) Pub. Date: Oct. 10, 2013

(54) AT HOME SERVICE QUOTATION PLATFORM AND METHOD

(71) Applicant: PEAK INNOVATIONS INC., Richmond (CA)

(72) Inventors: Simon Walker, Delta (CA); Kit Lee, Richmond (CA)

(73) Assignee: Peak Innovations Inc., Richmond (CA)

(21) Appl. No.: 13/856,988

(22) Filed: Apr. 4, 2013

Related U.S. Application Data
(60) Provisional application No. 61/620,139, filed on Apr. 4, 2012.

(51) Int. Cl. G06Q 30/06

(52) U.S. Cl. CPC G06Q 30/0611; G06Q 30/0617
USPC 705/26.4

(57) ABSTRACT

A quotation service platform customer service calls comprises a mobile device in wireless communication with a remote server. The server tracks the progress of the service call, provides a quotation for specified products to be installed, generates and delivers a contract to the device and supports scheduling of an installation. The server also provides a records management utility accessible from the device.

### RELATED APPLICATION

This application claims the benefit of U.S. Provisional Application No. 61/620,139, filed Apr. 4, 2012.

### FIELD OF THE INVENTION

This invention relates to a customer relationship management system. In particular, the invention relates to a CRM system and method for providing on-site sales support for home installation services.

### BACKGROUND OF THE INVENTION

A variety of home improvement products require professional installation. This is the case for example with roofing, siding, gutters, decks, fences, windows and doors.

Prior to undertaking the installation, the installation service company will typically dispatch a customer representative to the customer's home to discuss with the customer the selection of products to be used in the installation, to evaluate the scope of the home improvement project, to provide a quote to the customer, to secure an order and/or payment from the customer and eventually to schedule an appointment for the actual installation. The process of doing so can be cumbersome and drawn-out.

For example, a miscellany of product catalogs, quotation documents, order forms or contract documents are often brought to the customer's premises by the customer representative. The handling of bulky product catalogs or the management and filling out of the other documents involved in the project can be awkward for both the representative and the customer.

In some cases it is necessary to adjourn the customer service call while the representative develops or validates a quotation (including securing a quotation from the manufacturer of the product to be installed), confirms a customer's qualification, or retrieves and fills out order forms or contracts for eventual signing by the customer. Similarly, the availability of an installation crew might not be determined until the representative either makes appropriate enquiries of scheduling staff or registers the order for the installation project so that the job can be scheduled in due course. In most cases, the customer is told to expect a follow up call to schedule the installation. As might be expected, every adjournment of the sales process carries a risk of losing the order through as the customer reconsiders the project or its cost, becomes interested in alternative products or service suppliers, or due to other intervening events.

Inherent in being able to quote an overall installation cost to a customer is the need to secure a manufacturer's quotation for the products and materials involved in an installation. Simply referring to manufacturer price lists is not practical as many of the products to be installed as home improvements involve a degree of customization. For example, in the case of windows, different types, styles, frames, glass, grillwork, colours and treatments are available, and the specific size of the window must be chosen to accommodate the opening in which it is to be fitted. As a result, itemized manufacturers' price lists are often not applicable.

To address this, many manufacturers provide proprietary quotation software to enable a representative to interact with the software so as to effectively build the product specifications to the point that a quotation can be generated by the software. A representative will typically install multiple proprietary quotation software programs from a variety of different manufacturers on the representative's laptop, notebook or other portable computing device. Although prevalent in the industry, there are a number of drawbacks to that approach.

It is necessary for the representative to keep all of such software updated. The failure to do so can result in invalid quotations. In addition, there is a need to log into each manufacturer's software application, which may involve different user names and passwords for each manufacturer.

Manufacturers' quotation software involves varying approaches to updating the manufacturers' pricing. In cases where the user is expected to normally trigger a pricing update by polling a server controlled by the manufacturer, there may be latency problem with the price information used to secure the quotation unless the representative is particularly diligent in regularly updating the pricing.

Some currently popular portable computing devices have operating systems that are constrained as to the type of applications that can be run on the systems. For example, an iPad will often only be able to run Apple applications, while an Android-based device may only be able to run certain types of applications compatible with that operating system.

The quotation software suffers another limitation. If the quotation software is being used in the presence of the customer, the customer might be expected to see the product price quotation, but the representative will need to add a labour or service fee on top of the product price. There might also be preferential pricing that is somewhat sensitive from the point of view of the installation company. It is known to try to address that problem by incorporating into the manufacturer's quotation application a provision for a product mark up or the addition of a service fee so as to generate an overall quotation that can be presented to the customer. Such an approach involves arranging for each of the potential manufacturers to incorporate appropriate calculations to reflect the installation company's service fee and to account for any private discounts. In some cases, the setting of such a fee is not straightforward and can be challenging to implement in an automated system.

There are also limitations on the usefulness of the quotation software from the point of view of retrieving previously supplied quotes. The quotes obtained by the representative may be for different alternative products and/or from different manufacturers. When it is desired to retrieve a previous quote that a customer might show interest in, the representative has no convenient means of retrieving the quotes relating to a particular customer and manufacturer. Frequently, the representative will be forced to generate a new quote (unless he printed off a copy of a previous quote and hopefully organized it in such a manner that it can be retrieved at a later date).

Once a customer has accepted a quotation, an order must be confirmed or a contract entered into, typically including a form of payment. This can require the representative to prepare a written order or contract identifying the customer, the products to be used, the scope of work, pricing, payment details and other information. The process, whether done on the spot or during an adjournment of the service call and sale process, can be tedious and is subject to transcription errors. If such errors do occur, the installation will be delayed or losses will be incurred.

One aspect that is typically prone to transcription errors is the recordation of credit card information. These types of errors are especially severe as they usually result in a complete stoppage to the sales process. This problem may be further compounded by additional recordation and transmission steps owing to privacy concerns that disallow the permanent electronic storage of sensitive personal information. More specifically, full credit card information on a hand written costumer contract is redacted by the installation services company prior electronic storage. Redaction is typically effected by highlighting the credit card information with a light reflective marker that will appear blacked out once electronically scanned but remains readable to the eye. Also typically, after electronic storage, the credit card information will be required in typed electronic format for processing by a financial services company or other entity. The hand written credit card information must be manually inputted for temporary electronic storage and transfer each time it is thus required. In sum, transcription errors may occur at the initial field stage, and may occur multiple times at the data entry stage.

The response time and performance of a representative in closing a sale or completing the service call may be evaluated and tracked. This is particularly so when leads are generated by a lead management system on behalf of a third party who the customer expects be responsible for the provision of the service. Such third party is typically interested in fast responsiveness to leads and a quick follow-through to close the deal and complete the installation. Customer representatives may be very diligent in responding to the communication of a new lead by attending on the customer within days or even hours. Similarly, the representative may be very prompt in generating product and service quotations, in arranging for pre-measuring of the project, and in returning to execute and prepare copies of a product and services contract. This standard of responsiveness may be repeated on a continuous basis, keeping the representative very busy.

Unfortunately, tracking the representative's responsiveness from attending on the customer to securing a signed order is dependent on the tracking system being made aware of the attendance, securing copies of the quotes and of the signed contracts. A lead management system may prompt the representative for status updates, however, for busy representatives who are continually on the road and visiting customer premises, the collection, organization and logging of the paperwork associated with a quotation or signed contract is a burden compared to the primary importance of visiting customers and closing a deal. As a result, such administrative paperwork is often delayed. As a result, the actual responsiveness of the customer representative is not reflected in the tracking of the representative's performance. Apart from the failure to credit the representative for responsiveness, if the contract is not logged promptly, the installation will also be delayed, resulting in customer frustration.

There may be discount policies in place in connection with the pricing of installation services. Some discounts might be discretionary on the part of the customer service representative. In other cases, discounts may be set and controlled by the installation company which may want to have very uniform discount practices and which will therefore have strict guidelines in relation to discounts. In such cases, there is nonetheless the possibility that the customer representative will wish to provide discounts on a relatively subjective basis, thereby frustrating the discount policies of the installation service supplier.

After execution of the contract with the customer, and in some cases before a final price can be provided, a pre-installation visit by an installer may be required to more accurately measure the installation. This enables greater accuracy than a customer representative may have the time to achieve yet it may be critical to providing an accurate work order for the product manufacturer.

Where a pre-installation measurement is required, or to schedule a final installation, the representative will discuss possible installation appointments with the customer. In some cases the representative may be able to contact an installer on the spot, for example by telephone or electronically, and schedule a visit. However, when larger numbers of installations are involved, the ad hoc setting of appointments is not feasible. Instead, the representative undertakes to have someone contact the customer at a later date. The hiatus allows the representative or the installation company to secure an estimate of when the manufacture of the product will be completed. Contact can then be made with the customer to schedule an appointment. It will be appreciated that this involves disengaging with the customer until such time as the job can be processed, the products and materials ordered, a manufacturing time estimate secured and an installer contacted with the pertinent information to schedule a tentative appointment.

The prior systems also result in a distribution of the information relating to a specific job. The information may be recorded on paper, or perhaps electronically, but be known initially only to the customer representative. Other customer representatives will not typically be privy to the same information regarding the job unless they communicate directly with the attending customer representative or an enquiry is made of a central processing facility for the various jobs. It may be necessary to contact an installer if the question relates to re-scheduling a job.

The foregoing touch on some of the inefficiencies in the prior systems of securing orders, executing contracts and scheduling home improvement installation services. Other inefficiencies may be appreciated upon consideration of the invention, though perhaps not expressed herein.

It is an object of the present invention to overcome the aforementioned deficiencies. It is a further object of the present invention to allow the lead development process to mature into a scheduled installation order with as few visits to the customer premises as possible and to minimize the encumbrance caused by the need to retrieve and secure various quotation documents, contracts, catalogues and payment clearance instruments.

The invention disclosed herein provides a more convenient customer service call and sales process and one that enhances to prospects of closing the deal with a signed contract during the customer representative's initial visit. Other advantages of the invention include facilitating the quotation process from various manufacturers, better control over pricing, and better access to information relating to a particular customer lead or order.

These and other objects of the invention will be better understood by reference to the detailed description of the preferred embodiment which follows. Note that not all of the objects are necessarily met by all embodiments of the invention described below or by the invention defined by each of the claims.

### SUMMARY OF THE INVENTION

According to the invention, a mobile wireless communication-enabled device is provided to the customer representative. The device interfaces with a server that acts as a clearinghouse, records center and document generator for tracking the progress of a lead or sales call and serving to the device the various documents needed to progress the transaction and complete the order and installation.

The use of a properly configured server to support the on-site multimedia device provides the opportunity to solve many of the problems presented by the prior art.

The use of the device allows the presentation of various catalogs and demonstrative materials to the customer. When linked to the server, the server can ensure that the catalogs and materials are always current.

The server can deliver electronic documents to the device, avoiding the need for the representative to shuffle documents, and ensuring the consistency in the format and content of the documents.

The server may be configured to support such manufacturers' quotation applications as may be required by a customer representative. Preferably, the product vendor quotation system allows the application of a formula establishing a service or labour fee on top of the product and materials cost for the purpose of generating an overall materials and labour installed quotation. Alternatively, the server can secure, from the manufacturer's quotation applications, quotations for product only and apply a suitable service fee before serving an all-in quotation to the device for direct display to the customer.

When a customer representative wishes to work up a quotation in relation to a particular product vendor's products, he uses the multimedia device to remotely log into and activate the vendor quotation software that is run on the server. It will be understood that the representative may do this for any number of product vendors. This arrangement allows for a multitude of product vendor quotation applications to be run on the server without regard to the particular operating system or hardware limitations on the multimedia device.

In yet another alternative the server may provide flow-through to access the product vendor's quotation system server, relying on software loaded into the device.

The server can draw upon the entirety of the service supplier's resources, including service fees, discount policies and product vendor's pricing, to develop and deliver a complete and final quote to the device.

When the quotation has been worked up, it is formalized, converted to an image format and appropriate service supplier letterhead may be added. The completed quote is then forwarded to the device and stored in a database associated with the service supplier.

The server may also provide a centralized credit authorization and payment processing system. Transcription errors are also avoided entirely in relation to credit and processing and are minimized in relation to customer identification information as the customer may review the device display for accuracy.

Since the server delivers the quotation and performs payment authorization, it is also in a position to format and deliver a contract to the device for electronic signature by the customer, allowing the sale to close in a single visit.

The server also enables a centralized job scheduling facility, accepting scheduling and availability inputs from sales staff, pre-measuring staff, installers, inventory records and product delivery time estimates, and instantly confirming a suitable appointment.

The server may act as a document centre, enabling the retrieval by any authorized party of copies of quotations, product specifications, contracts and scheduling information.

As the customer service call is centrally monitored and facilitated by the server, tracking of the progress of a service call is easily performed without the need for the representative to collate, organize and deliver paperwork to the supplier.

Therefore according to one aspect the invention comprises a quotation service platform for facilitating a product sale and installation quotation sales call. The platform comprises a server and a mobile device in wireless communication with the server. The server has instructions that cause the server to accept data from the mobile device, to monitor the progress of the call based on the data, and to collate the data to prepare and serve to the mobile device a display of a quotation, a contract or a schedule.

The data may comprise a plurality of data sets received from the mobile device at different times during the call. The server acts as a records center, saving copies of the data sets and serving up a display to the mobile device upon request.

The mobile device may be configured with a plurality of software modules, each module being independently selectable by a graphical user display, and the modules comprising at least two of a quotation module, a contract module or a scheduling module. The quotation module is configured to accept product information that is manually entered on the device and to transmit a request for a quotation to the server. The contract module is configured to accept an indication of acceptance of a quotation that is manually entered on the device and to transmit a request for a contract to the server. The scheduling module is configured to transmit a request for appointment availabilities in response to a manual request entered on the device.

In another aspect of the invention, the server further accesses an availability schedule of product installers. Upon receiving from the mobile device a confirmation of an installation appointment, the server populates the availability schedule with the appointment.

In another aspect, the device comprises a product catalogue stored on said device.

In a further aspect, in response to a request for a quotation received from the mobile device, the server retrieves vendor product cost information and predetermined service fee rate information, calculates a quotation based on them and delivers a quotation to the device.

The server may retrieve the vendor product cost information from its own storage resources or it may secure it from a vendor server.

In yet another aspect, in building a quotation, the server may verify a quotation for compliance with stored discount policies.

In another aspect, the server authorizes credit and verifies a customer identity based on a request received from the device and delivers an authorization or a refusal of authorization to the device.

In a method aspect, the invention comprises a method of conducting a product installation sales call. According to the method, a sales representative attends at a customer's premises with a mobile device that is in wireless communication with a remote server. During the call, the representative inputs client identification and product identification information on the device, which transmits the information to the server which receives and stores them. Upon receiving a request for an installation quotation from the device, the server prepares an installation quotation based on data that comprises the client identification and the product information and delivers the installation quotation to the device. Upon receiving payment information and a request for a contract from the device, the server prepares a contract based on the installation quotation and delivers it to the device.

The data may further comprise vendor product cost information and installation service fee information.

The step of preparing an installation quotation may comprise communicating with a product vendor server and securing the product cost information from the product vendor server rather than from a database associated directly with the server.

In a more particular aspect, the installation service fee information may comprise service fee rate information and the step of preparing an installation quotation may comprise retrieving the service fee rate information from storage means associated with the server.

The steps of delivering the installation quotation and delivering the contract may comprise delivering images of documents representing the installation quotation and the contract and storing the images in storage means associated with the server.

In another aspect, the method may further comprise the steps of the representative entering payment information on the device, the customer verifying, visually or otherwise, the payment information and the server processing payment through a credit facility.

The foregoing was intended as a broad summary only and of only some of the aspects of the invention. It was not intended to define the limits or requirements of the invention. However, the scope of the claims should not be limited by the preferred embodiments set forth in the examples, but should be given the broadest interpretation as a whole.

### BRIEF DESCRIPTION OF THE DRAWINGS

The invention will be described by reference to the detailed description of the preferred embodiment and to the drawings thereof in which:

FIG. 1 is a diagrammatic view of the system of the preferred embodiment;

FIG. 2 is a block diagram of the functional components of the portable device according to the preferred embodiment;

FIG. 3 is a front view of the preferred embodiment of the portable device according to the invention showing modules for selection by the representative;

FIG. 4 is a block diagram of the functional components of the server according to the preferred embodiment; and,

FIG. 5 is a flowchart of a process according to the preferred embodiment of the invention.

### DETAILED DESCRIPTION OF THE PREFERRED EMBODIMENT

In the following detailed description the preferred embodiment and various alternative embodiments of the invention are described. Each of the preferred and alternative features described herein is not necessarily part of the invention over which claims will be asserted but are included for a full specification of how to implement at least one practical embodiment of the invention.

This description will proceed as follows:
I. System Overview
II. Overview of Portable Multimedia Device
III. Overview of Server
IV. Device Modules and Service Call Sequence
V. Server Functions
VI. Interactive Process

### I. System Overview

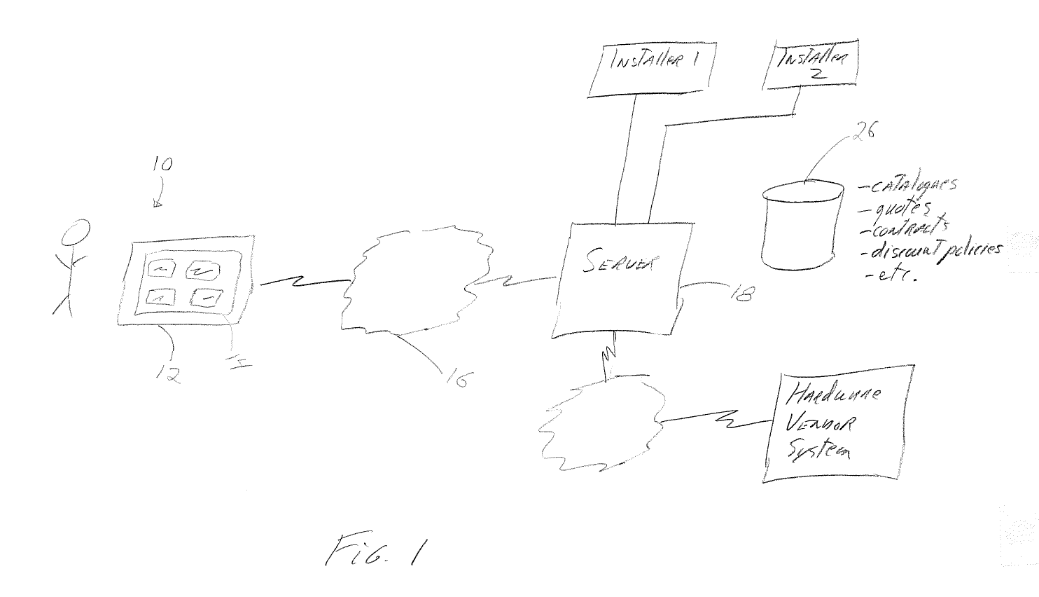

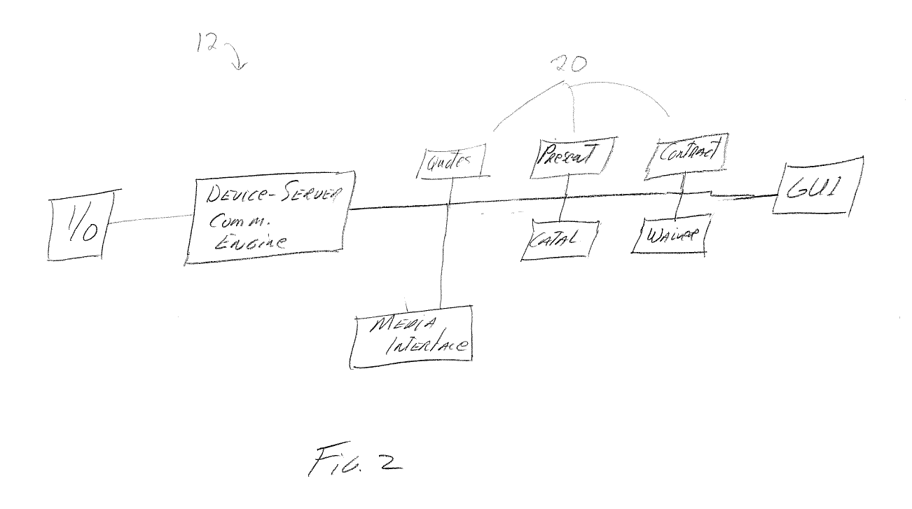

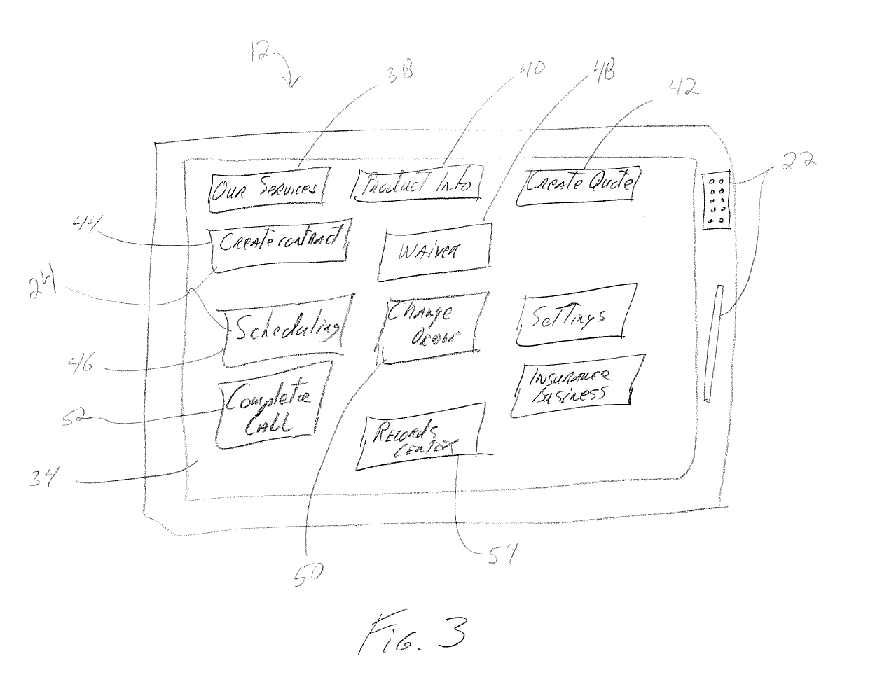

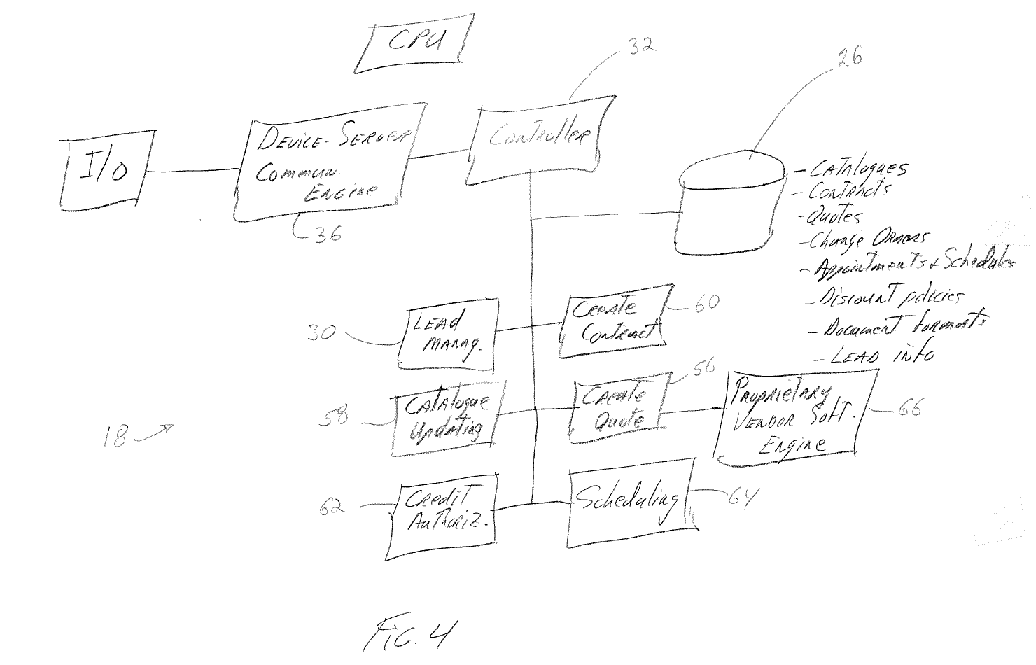

Referring to FIG. 1, a customer service representative attends at customer premises 10. The representative is equipped with a portable wireless communication-enabled device 12 having a user interface 14 for supporting the customer service function. The wireless communication capability of the device enables it to network over a wireless communication network 16 with a remote customer relationship management support server 18.

The server 18 acts as a clearinghouse, records center and document generator for facilitating and tracking the progress of a lead or sales call and serving to the device 12 the various documents needed to progress the transaction and complete the order and installation. In instances where the representative would otherwise need to adjourn the customer meeting in order to secure further information, documents or authorizations, the device 12 communicates with the server 18 which serves up the information, documents or authorizations on an as needed basis. Server 18 also collects and manages the information needed to support requests from device 12.

The representative's attendance at the customer premises is typically in response to a customer lead. The lead may be generated by a lead management system 30 that delivers to the representative the coordinates of a customer interested in home equipment installation services. According to the preferred embodiment, the lead management system 30 consists of an application resident in server 18 and embodies the features disclosed in US Patent Publication No. 20100257012 published Oct. 10, 2010. The lead is delivered from the lead management application 30 through the server 18 to the device 12. In one embodiment, server 18 may be viewed as an application within the lead management application.

The lead management application 30 may track the progress of the lead in real time through the order and installation process through the interactions between the server 18 and the device 12.

The device 12 includes a number of modules 20 each of which may be run in response to the representative selecting the given module. Specific modules support specific steps in the customer service call process and several of the modules are intended to be used in sequence through the call process. As the modules run, requests and tracking information may be sent from the device 12 to the server 18. The requests request action on the part of the server, such as creating a quotation. Tracking information is delivered to the server to enable the server to collect the information necessary to execute server functions, for example creating a quotation at a later point in the service call. The tracking information may also be used to track the progress of the service call for lead management and performance evaluation purposes.

As a service call is undertaken, the representative enters the customer's name or address on the device 12 which communicates the information to the server 18. In one embodiment, the lead management program 30 may track the GPS location of the device carried by the representative and may deduce which customer is being visited by the representative, followed by a prompt to the device requesting confirmation from the representative that a service call is being initiated with a particular customer.

Server 18 communicates the initiation of a customer service call to the lead management application 30 which can begin logging the contact with the customer and tracking the progress of the call through the interactions between the device 12 and the server 18.

The lead management system 30 also correlates the customer information supplied by the representative's inputs to the device 12 to a particular lead. That enables the lead management system to supply additional information on demand to the controller 32 or to other modules such as further particulars of the customer, of the project and of the entity that originally generated the lead and on whose behalf the customer service call is being conducted.

### II. Overview of Portable Multimedia Device

Device 12 is wireless communication-enabled, for example enabling communication through the Internet through a local Wi-Fi connection or through a cellular or satellite network.

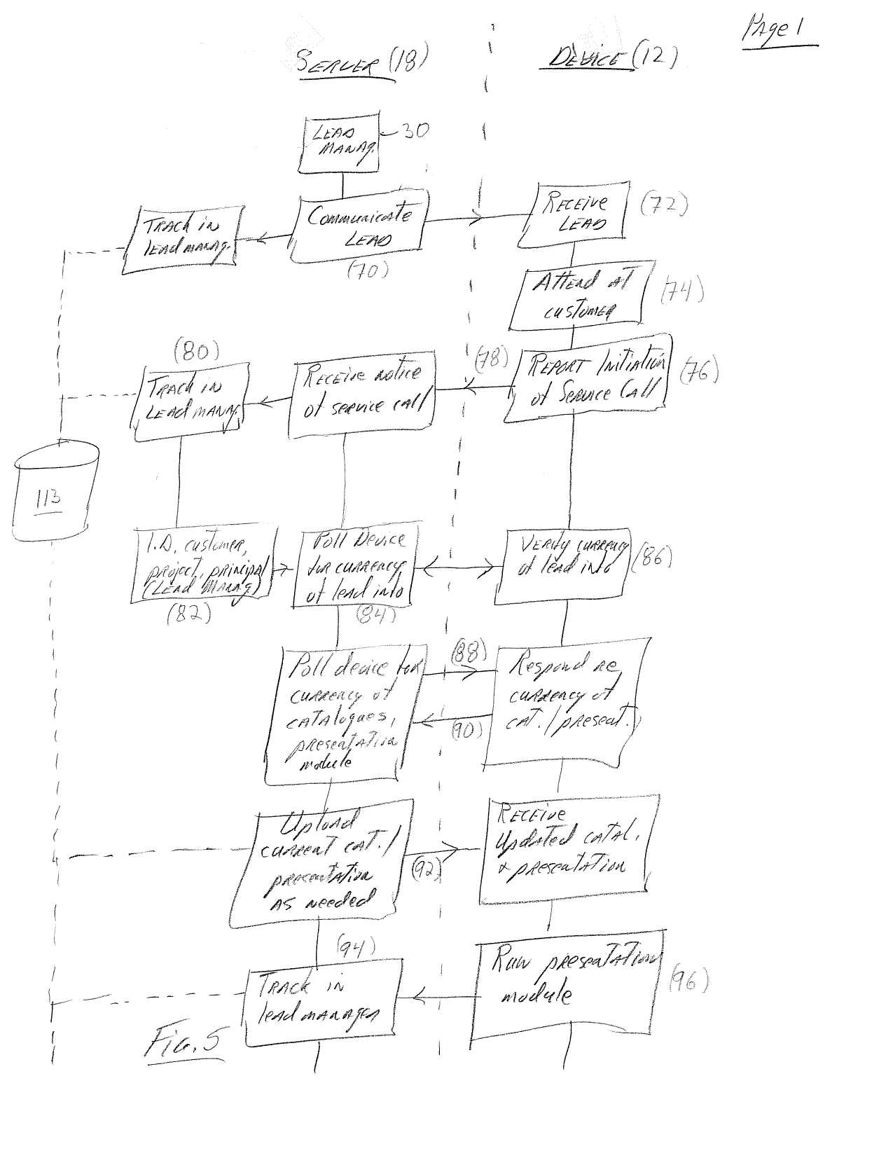

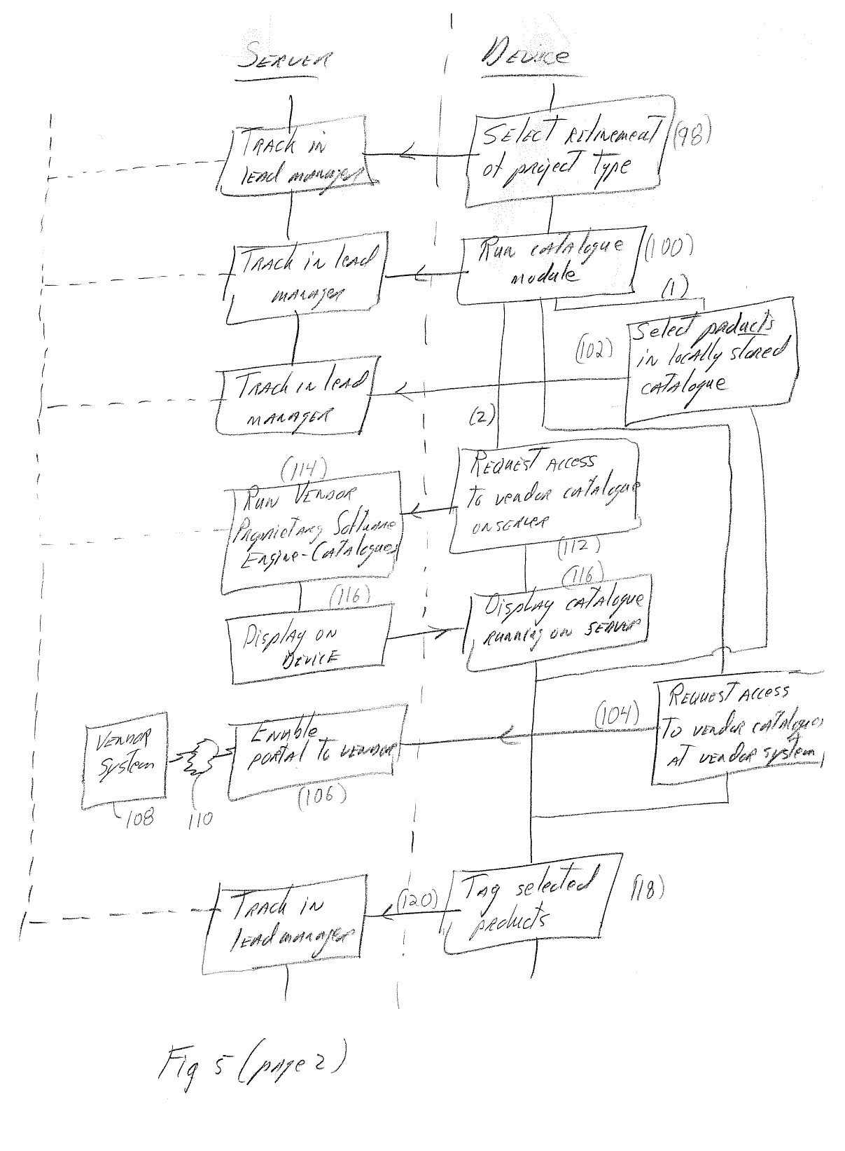

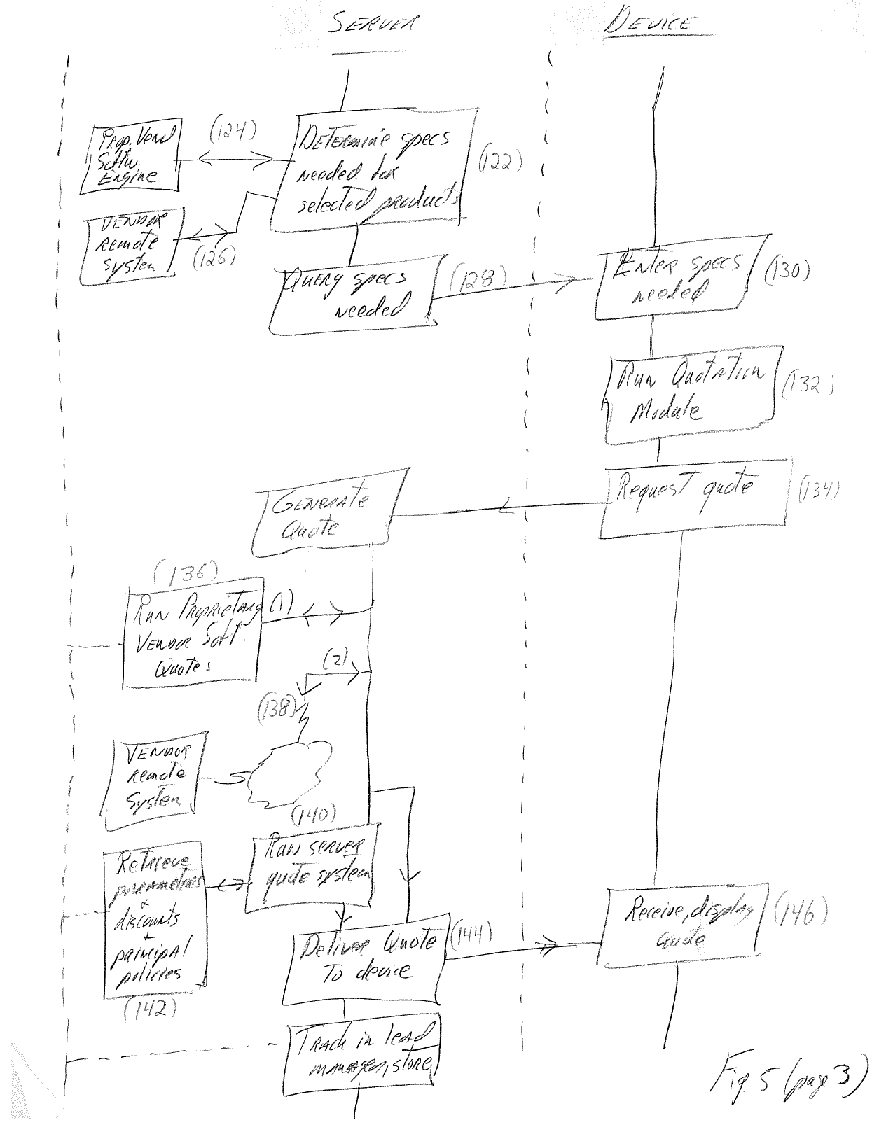

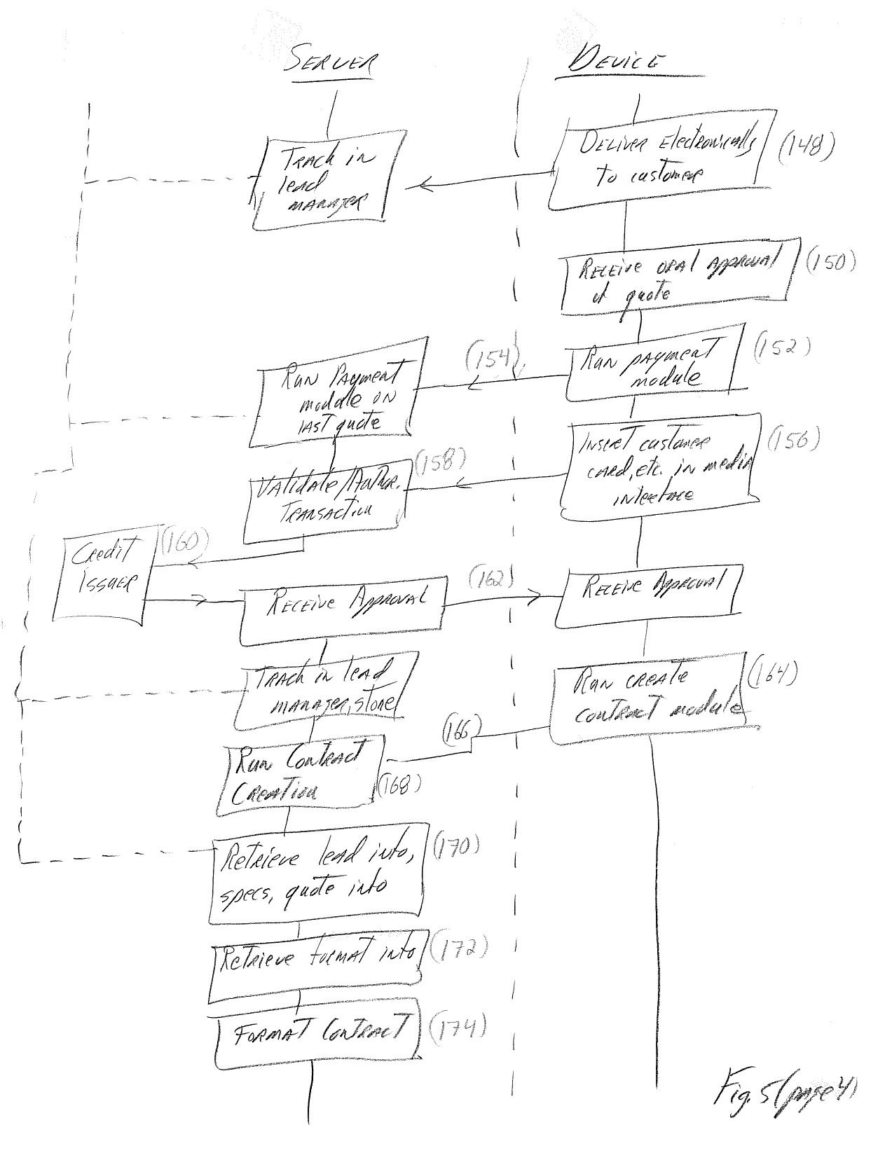

Referring to FIG. 3, device 12 includes a display screen 34 (ideally a touch screen) as well as a user interface for allowing the representative or the customer to input text or data to the device 12. Conveniently the user interface can include a virtual keyboard displayable on the touch screen.

According to the preferred embodiment, device 12 also includes a media interface 22 for reading financial data from suitable media (for example a credit card) presented by the customer, and means for capturing a signature or an authorization from a customer, such as a signature capture utility on a touch pad, or a customer triggering the radio or Wi-Fi transmission of an authorization.

Device 12 includes a plurality of software and user interface modules 24 for facilitating and guiding the representative through the sales process and for presenting displays to be viewed by the customer. Software and user interface modules 24 preferably include:
Presentation (“Our Services” 38)
Catalogue (“Product Info” 40)
Quotation 42
Contract Generation 44
Scheduling 46
Waiver 48
Change Order 50
Complete Call 52
Records Center Access 54

Each of the modules is represented on a home screen of the device by an icon as illustrated in FIG. 3. Selection of a given icon causes the module to run and to present a display to the customer and/or the representative.

The applications supporting the modules may be loaded onto device 12 or may be accessed remotely, by device 12 on an ASP model. In the latter case, the device 12 may be limited to providing a user interface for the display of module icons and options, and input means for entering data as may be required. Preferably device 12 stores and runs software locally so as to minimize the bandwidth requirements of the communication channel with server 18.

### III. Overview of Server

The server 18 is wireless-communication enabled.

The server system includes a device-server communication engine 36 to establish and maintain a session with the device 12. In the course of the session the controller 32 monitors incoming module-specific indicia and requests from the device as the representative progresses through the service process. The controller routes the requests to the appropriate modules for service, receives the response(s) from the appropriate server modules or database, and responds to the device as required.

For example, in the course of the service call, the representative may run the quotation module 42 on the device. After entering the information required to generate a quote, a “request quote” function 42 is initiated on the device. The device's quotation module 42 directs a request quote instruction to the server 18 along with the data required from the customer end to create a quotation. At the server 18, the request quote instruction and data are received by the controller 32, which determines that the appropriate module for responding to the request is the server's “Quote Generation” module 56, also drawing on lead tracking information in a database 26 to identify the customer, the address, the retailer who generated the lead, the hardware vendor and product details (which are communicated to the server either during the quotation module process with the customer or by being tagged as the desired products in the catalogue module process with the customer).

A database 26 is associated with server 18. As will be discussed below, database 26 is used to support the records center facility of the server and to store information relating to the lead and the service call as it progresses. The records center facility retains and delivers on request records or images of quotes, orders, contracts, scheduling information, response tracking data, payment data and financing data relating to a lead, among other things.

Server 18 further preferably includes the following facilities implemented in software modules:
Catalogue facility 58
Quote Generation 56
Contract Generation/Payment/Credit Authorization and Processing 60, 62
Scheduling 64
Lead Management and Tracking 30

### IV. Device Modules and Service Call Sequence

The presentation module 38 is used to provide to the customer an audio-visual outline of the customer service call process and may include promotional material relating to the home installation services company or the entity on whose behalf the home installation services company is acting (for example a retailer who might have generated the customer lead). In one embodiment, the presentation module also includes a prompt for entering the name or address of the customer which may be used as the triggering event for the establishment of a session with the server 18.

The representative may then initiate the presentation module 38 for the customer's viewing on device 12. The presentation module includes an audio-visual introduction to the installation service supplier's services and quality of service and an outline of the sales and installation process that the customer is about to undertake.

The presentation module 38 may include a menu of general types of installation projects for selection by the representative. Each menu item further presents the customer with an audio-visual outline of the general types of options available for the particular project that the customer has in mind. This serves to narrow the specifications and parameters of the installation project. Each of the selections is communicated to the server 18 thereby informing server 18 of further particulars of the type of project involved. Server 18 may correlate such selection with the type of project recorded in the lead management system 30, generating a verification prompt to device 12 in the event of a discrepancy.

The content of presentation module 38 may be loaded in memory in device 12, with automatic updating of the content by server 18 upon initiation of an In Attendance session, or at any other time device 12 initiates a communication with server 18. As each session is initiated, server 18 polls device 12 to determine the currency of the presentation module 38 that is loaded on device 12 and downloads any updated version as may be required. Alternatively, the content of the presentation module 38 may be entirely downloaded interactively in real time from server 18, obviating the need to store the content locally on device 12 and avoiding the need to update locally stored content on the device. After discussion and refinement of the customer's installation needs, the representative causes device 12 to run the catalogue module 40 to display and demonstrate to the customer potential products available for installation. Device 12 presents a menu of possible product vendors available for the installation project. Selection of a given vendor triggers the opening of that vendor's catalogue of products.

The catalogues of vendor products that are presented by the catalogue module 40 are maintained current by server 18, server 18 determining from device 12 which editions of the catalogues are currently saved on device 12 and downloading updates as needed. Such updating of the catalogues may be performed any time device 12 is in communication with server 18, but according to the preferred embodiment the updating is performed seamlessly at the initiation of each In Attendance session with a customer. Reference prices associated with the catalogue items, if available, are similarly updated and maintained current by server 18. Alternatively, as in the case of the presentation module content, the content of the catalogue module 40 may be entirely downloaded interactively in real time from server 18 in an ASP model, obviating the need to store the content locally on device 12 and avoiding the need to update locally stored content on the device.

In some cases, the individual vendor catalogues are maintained only on the vendors' own servers, and that may require certain applications to be run in order to access the catalogues. For example, where the pricing of a product is variable and dependent on product specifications, as is the case for windows and doors, the price can not reasonably be determined until the product specifications are provided as prompted by a vendor quotation engine 66. In such cases, the applications required to access the vendor catalogues are run on server 18 and the resulting pages are served up to device 12 by server 18. This arrangement allows device 12 to access the catalogues of various vendors without requiring the vendor software to be loaded directly onto each device 12. It also allows updates to the vendor software to be made at a single location, namely at server 18 for effective access by all devices 12 that may be associated with server 18.

Alternatively, the vendor software application may be made available to the device 12 and loaded on the device, in which case the device 12 runs the application with server 18 acting as the server, with server 18 providing network access facilities to the vendor catalogue server.

The representative and the customer identify candidate product and materials options for the project, which are saved on device 12 and are communicated to server 18. Once the customer has settled on a particular suite of products for the installation, the representative tags the products on the catalogue module 40, the product selections being automatically communicated to server 18.

The representative then initiates the quotation module 42 on the device 12 including a request to generate a quotation for the customer. The quotation module 42 includes a quotation engine that determines the parameters needed to generate an effective quotation. A quotation interface to device 12 prompts the representative to determine and enter various installation parameters associated with the project. This enables the quotation system to estimate the labour and other costs to be incurred in the project.

The quotation system 56 at the server 18 draws upon the customer identification and address information generated at the outset by the lead management application 30. The general type description of the project is drawn from the type of project selected in the course of viewing the presentation module 38. The particular products to be referenced in the quotation are drawn from the tagging of the products from the catalogue module 40 and the confirmation of the selection of those products by the representative in the quotation interface.

The service fees and incidental costs to be included in the quotation are drawn from the representative's specification of the installation parameters as prompted by the quotation module. Any discounts or promotions that may be available to the customer are drawn from the service installation company's discounts and promotions engine and database 26 that are associated with server 18.

The server quotation system 56 generates a complete quotation document including appropriate logos, trademarks and letterhead and entries identifying the customer, the project, the materials and their cost, the service and incidental fees, applicable taxes and any discounts and promotions that apply. The quotation data as well as an image of the quotation document are stored in a Documents Center which may be part of database 26 and are associated with the project, the customer and the representative. An image of the quotation document is displayed to the device 12, and the event is recorded by the lead management system 30. Device 12 further displays an option to deliver an electronic copy of the image of the quotation document to the customer via email or to upload it to a local printer or other customer communication device. The lead management system 30 tracks the communication of the quotation document to the customer, including the means by which it was communicated.

Once the customer has approved the quotation, the representative runs the Create Contract module 44 which triggers a request to the server to create a contract. The server returns to the device a form of contract, preferably as an image file, for display to the customer. The customer is invited to sign the contract, for example using a touchpad signature. This is similarly communicated to the server which then returns an image of the signed contract to the device, which may then forward the image to an electronic address or by local transmission to the customer.

An enquiry is made of the customer as to the means of payment following which the payment module is run. The payment module may be part of the create contract module 24. In the case of a credit or debit transaction, a customer media such as a credit card or another form of storage of financing data is interfaced to the media interface 22 on the device 12. The information is forwarded to the server 18 which then conducts an authorization process and returns a confirmation to the device 12.

The customer's signature on the contract may also be represented and used as a final authorization to debit or apply credit to the customer's account.

The Scheduling module 46 may then be run. The module communicates with the server to secure available installation dates, or if necessary a further pre-installation measurement service call. The server queries its own scheduling utility 64 that includes a scheduling manager for its installation personnel. The server scheduling utility 64 may also account for typical lead times for the supply of certain products from hardware vendors. Available dates are returned to the device 12 and are selected by the customer. The scheduling module then returns the desired date to the server, which responds with a confirmation.

The service call is then complete. A “Complete Call” module 52 may prompt the representative to verify that all aspects of the call have been completed, and to conduct any closing interactions with the customer. The closing of the “Complete Call” module signals the tearing down of the session with the server.

A Change Order module 50 may be used for those occasions where a customer wishes to change a previous order. Upon running the module, the representative enters the lead tracking information to identify the previous order. The information is communicated to the server, which retrieves the contract from the Records Center (in database 26), which is then displayed on the device 12. An interface is then presented on the device 12 enabling the representative to determine the desired changes on the order.

Once the desired changes are identified, the Quotation module 42 is run under the control of the Change Order module 50. Once the quotation is approved by the customer, and a payment adjustment is authorized through the customer, the Change Order module 50 generates a request to the server 18 to modify the contract accordingly. The server executes the changes and stores in the database 26 the new version of the contract, which is also communicated to the device 12 for display and forwarding to the customer.

A Waiver module 48 is used when attending at a customer following completion of an installation project. The customer is invited to sign a waiver to confirm satisfactory completion of the project. The signed waiver is forwarded to the server for retention in the Records Center.

### V. Server Functions

### Records Center (26)

In association with database 26, server 18 may act as a document centre, enabling the retention and retrieval by any authorized party of copies of quotations, product specifications, contracts and scheduling information. The server can then deliver electronic copies of the documents to the device on demand, avoiding the need for the representative to shuffle paper documents, and ensuring the consistency in the format and content of the documents.

The Records Center functionality may be used during a service call or at any other time.

### Catalogue Facility (58, 26)

The Catalogue facility serves as a current catalogue database for hardware vendor products associated with the installation business. The facility regularly communicates with the hardware vendors to maintain current versions of the catalogues on hand, without the need for the device to regularly poll the vendors directly.

The Catalogue facility may also be configured to poll each device at regular intervals to determine whether a download of updated catalogue information is necessary. Such polling and downloads can be performed at regular intervals according to a schedule maintained at the server, or they can be performed each time the device initiates a customer service call session with the server.

The catalogues may or may not include pricing. In the event that they do, the Catalogue facility can include a pricing update function to act as a centralized point of contact for vendors to update their product pricing, or product pricing policies.

### Quote Generation (56)

The generation of quotations involves either predicting the prices that will be charged for a given hardware product of determined specifications or is done interactively with the vendor. In some cases, proprietary vendor software is allowed to be run on the server to interact with the vendor's own in house quotation server to generate quotations on demand. Server 18 includes a vendor software engine for running such proprietary software including doing so in any operating system that may be required by the proprietary software. This avoids the need for the portable device to be compliant with a variety of different operating systems.

In other cases, a web interface to the vendor's in-house quotation system is used. Again, the server takes on the burden of such interaction to generate the quotations that are then delivered as finished products to the device 12.

When predicting (rather than interactively securing) prices from a vendor for use in a quotation, the Quote Generation module 56 also takes into account pricing policies and discounts that may be communicated to the server 18 by the vendor from time to time.

Discounts may be applied not only by the hardward vendors but by the principal for whom the service call is being made or by the installation company. The Quote Generation module 56 draws on a centralized store of discount policies for such entities, which may be retained in database 26.

Preferably, the product vendor quotation system allows the application of a formula establishing a service or labour fee on top of the product and materials cost for the purpose of generating an overall materials and labour installed quotation. Alternatively, the server can secure, from the manufacturer's quotation applications, quotations for product only and apply a suitable service fee before serving an all-in quotation to the device for direct display to the customer.

### Payment and Credit Authorization (62)

The server provides a centralized payment and credit authorization and processing system.

Transcription errors are avoided entirely in relation to credit information processing as the financial data is read directly from the customer media into the media interface of the device and is transmitted to the server. Transcription errors are also minimized in relation to customer identification information as the customer may review the device display for accuracy before the information is sent to the server.

In the case of payment by credit, the server retains the full credit card information only so long as is necessary to authorize the transaction and to push through a payment request to its destination. In one embodiment, the attending customer service company acts as an agent for the entity that generated the lead. In such case, the credit card information destination is that entity, which will eventually receive a copy of the signed contract along with full credit card information. Once the server has dispatched either a payment request or the signed contract and full credit card information to the principal, the server only retains and stores an abstracted or truncated version of the full credit card number.

### Contract Generation (60)

Since the server delivers the quotation and performs payment authorization, it is also in a position to format and deliver a contract to the device for electronic signature by the customer. From the device point of view, preferably the payment and payment authorization function is experienced as part of the contract generation step.

The contract format may be dictated by the party on whose behalf the service installation company is making the customer service call. The Contract Generation facility determines such format by querying the lead management system 30 to identify the party that generated the lead and on whose authority the service call is being made, and retrieves from the Records Center 26 the contract format and content policies specified by that party.

Once the contract is generated, including applying appropriate letterhead, logos, terms and prices, an image of the contract is sent to the device, preferably along with a copy of the quotation, and a copy is recorded in the Records Center.

The Contract Generation module tracks the signing of the contract by the customer, prompting the device in the event that a signature has not been secured for a period of time. Once the signed contract is received by the Contract Generation module, the lead management system is updated to reflect a signed order and an image of the signed contract is stored in the Records Center.

### Scheduling (64)

The server enables a centralized job scheduling facility, accepting scheduling and availability inputs from time to time from service call representatives, pre-measuring staff, installers, inventory records and product vendor delivery time estimates. This provides for a single point of contact for scheduling inputs and appointments.

### Lead Management and Tracking (30)

Each time the device 12 communicates an event or makes a request to the server, information may be provided to the lead management system for performance and statistical purposes.

The lead management system also acts to build up information regarding the lead, which information is drawn on at subsequent steps in the service call process. For example, when the data necessary to generate a quotation is supplied by the device, the lead manager stores the data for potential later use in the course of generating a contract.

### VI. Interactive Process

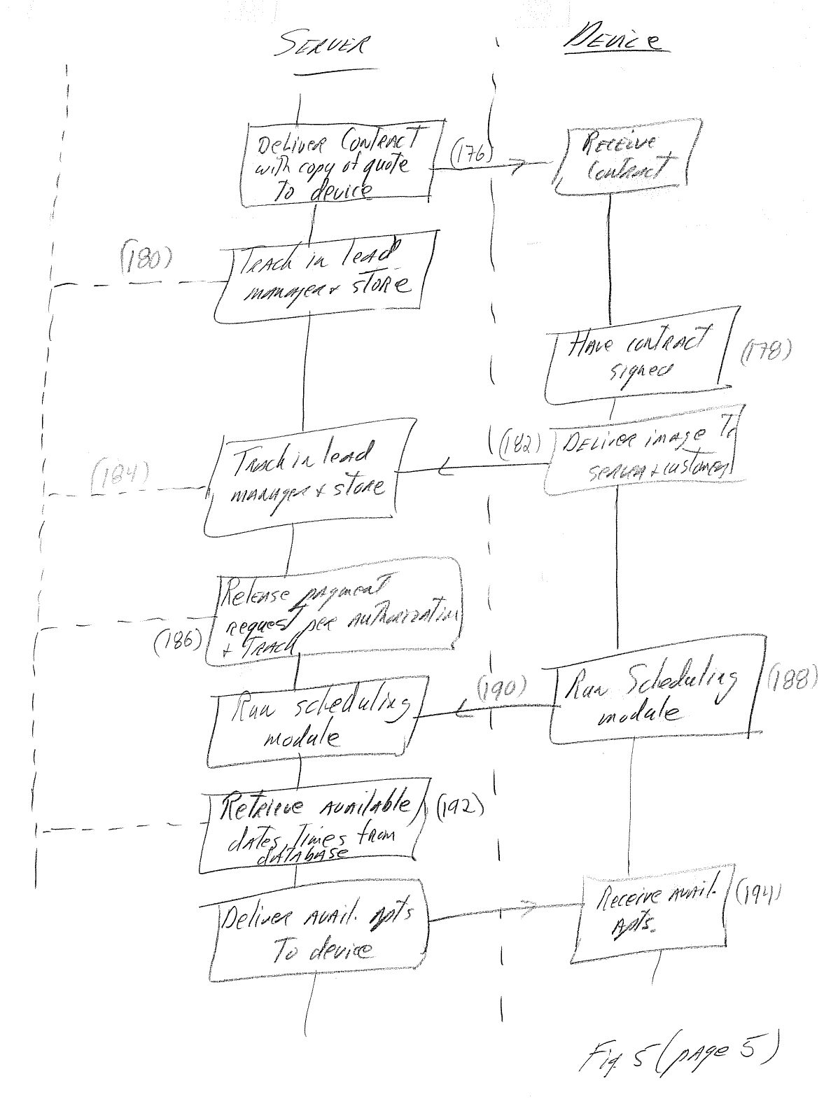

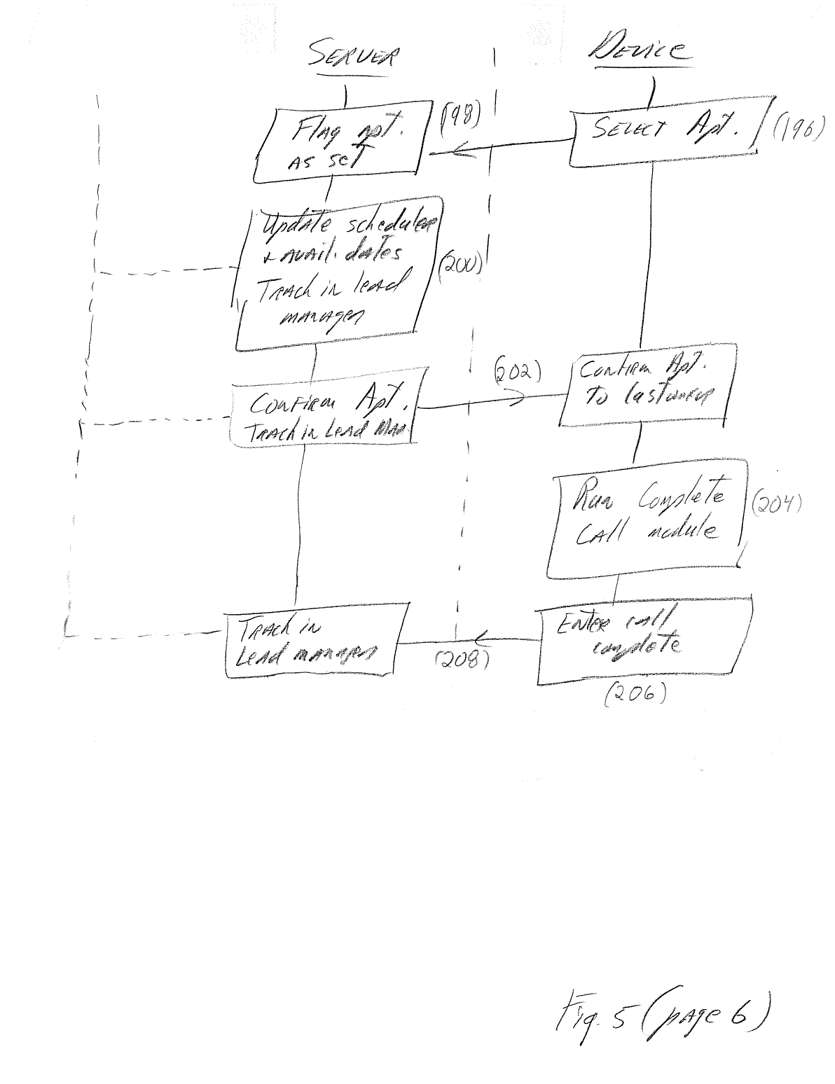

FIG. 5 illustrates and details a process implemented by a preferred embodiment of the invention.

The lead management system 30 residing at a server 18 generates and communicates 70 a lead to the device 12. After receiving 72 the lead, the customer service representative attends 74 at the customer premises. The representative accesses a record of the customer lead. Device 12 may include the display of an “In Attendance” icon that may be selected by the representative to effectively report 76 the initiation of the service call. The In Attendance module may prompt the representative to enter the customer's name or address. Activation of the “In Attendance” module causes the device 12 to communicate 78 with server 18 to request the establishment of an “In Attendance” session. The session is established enabling the exchange of data and the tracking 80 by the lead management system 30 of the progress of the call and recording such progress in server database 113.

As noted above, the establishment of a session between the server 18 and the device 12 includes information identifying the customer, which in turn allows the lead management system to extract further particulars of the customer, as to the nature of the project and identifying the party that generated the lead and on whose behalf (the “principal”) the customer service call may be conducted. For example, the input by the representative of the name “Joaquim Romano” or alternatively simply an address, might be expanded 82 by the lead management system as:

| | |
|---|---|
| Customer | Joaquim Romano |
| | 555 Main Street |
| | Thrashing, Minnesota |
| Project | Window replacement |
| Lead principal | Big Box Retailer |
| A (St. Paul Store 222) | |
| Date | Jan. 1, 2020 |

The information as to the lead principal is significant as it may govern the protocols to be followed in relation to how a quotation or a contract are created, their format, the prices, the terms, any expression of guarantees and their other content. Such protocols may in fact be dictated by the principal for whom the service call is ultimately being conducted.

The expanded lead information may be communicated 84 to the device for verification and reference purposes by the representative, in the course of which the currency of the lead information may also be verified 86. That functionality may conveniently be incorporated into the device's presentation module.

Similarly, the server may poll 88 the device to determine the currency of the product catalogues and of the presentation module information that may be stored on the device 12. The device 12 responds 90 by reporting the currency of the information. In the event that the information recorded on the device is not current, current information is uploaded 92. The tracking of the progress of the session and of the lead continue to be tracked 94 by the lead management system. Once updated (if needed) the presentation module runs 96 on the device 12.

The presentation module, or alternatively the catalogue module may prompt 98 the representative to narrow the specification of the type of product to be installed. The catalogue module is then run 100 to allow the customer to select 102 preferred products, for example by type, by grade, by colour, etc. from catalogue information stored locally on device 12.

Alternatively, the catalogue module may be directed to request 104 remote access to a catalogue maintained by a vendor system. In such case, the server 18 acts as a portal 106 to communicate with the vendor system 108, typically over the Internet 110. As discussed above, the server runs any required software and operating system to facilitate interaction with the vendor system 108 and to avoid the need to have such software and operating systems loaded onto the device 12.

In a further alternative, the catalogue module requests 112 access to the vendor catalogues that are stored in the server database 113. These may require the server to run 114 vendor-specified software or operating systems that are compatible with the vendor catalogues. In such case, the server returns 116 the information to the device 12 for display thereon 116.

The customer will select from the display on device 12 specific products the installation of which is being contemplated. Such products may be tagged 118 on the device 12. The tagged product is communicated 120 to the server 18 allowing the latter to determine the types of further specifications needed to plan the installation and to provide a quote. For example, the selection of a particular brand of window may still require a specification of the dimensions, type of frame, treatments and colours. The determination 122 of what additional specificatons are need in order to move forward may be derived from the proprietary vendor software engine run 124 from the server, or alternatively by the server remotely accessing 126 the vendor system. The device 12 is then queried 128 as to the additional specifications that are needed. The representative consults with the customer and enters 130 the specifications on the device.

The quotation module may then be run 132. The module requests 134 a quotation from the server 18 running the server quote generation system.

The quote generation system may derive a quotation by running 136 proprietary vendor quotation software that has been loaded onto the server 18 in conjunction with accessing static vendor pricing information retained in server database 113, or by remotely accessing 138 the vendor system where the quotation is generated directly. Such interaction allows the server to generate a product price quote. Conceivably the proprietary vendor quotation software or the remote vendor quotation system are configured to include installation fees along with product pricing. In other cases, such systems deliver only a quotation for product pricing, without installation or service fees.

The quote generation system may run natively 140 on the server 18. The server quotation generation software also draws 142 on various parameters, discounts that may apply and policies established by the principal in relation to the filling of installation orders and quotations.

Once generated, the quotation is formatted according to the system's, the vendor's or the principal's policies and is delivered 144 to the device 12 where it is displayed 146. The quotation is also saved into the server database 113. The device may prompt the representative to offer to the customer to deliver 148 a copy of the quotation electronically to the customer. Upon the customer's approval 150 of the quotation, the representative runs 152 the payment module on device 12. The device payment module communicates 154 a request to the server which runs the server payment module.

The device payment module prompts the user for an interaction with a customer payment medium (for example a credit card or other personal payment device). The customer payment medium is inserted into or wireless connects to the device media interface (156). The server payment module validates and authorizes 158 the payment transaction, which may involve an interaction 160 with a credit issuer or other third party payment provider. Approval is then communicated 162 to the device payment module.

The contract module is then run 164 on the device. Additional information as required is secured and filled into the device interface and is delivered 166 to the server which runs 168 the server contract creation module. The latter retrieves 170 information from the server database 113 (which may include customer name, address and contact information, product specifications, and quotation information). The module then draws 172 on formatting guidelines for the contract and prepares 174 a form of contract.

A prepared contract is delivered 176 to the device and is stored 180 in the server database 113. The customer is then invited to sign 178 the contract on the device user interface. An image of the signed contract is delivered 182 to the server which stores 184 the image in the server database 113. The lead management system 30 continues to track the progress of the call, noting that a milestone of contract signature has been achieved by the representative.

Upon determination that a contract has been signed, the server causes the release 186 of a payment request corresponding to the earlier payment authorization.

The scheduling module is then run 188 on the device 12. That module communicates 190 with the server's scheduling module which retrieves 192 available appointment dates and times corresponding to a roster of qualified installers determined by reference to the nature of the installation. The device receives 194 the available appointments and the customer selects 196 a suitable appointment. The server's scheduling module flags 198 the appointment as having been set and updates 200 a master schedule of available appointments accordingly. The appointment is then confirmed 202 to the device.

Device 12 may include a Complete Call module that is run 204 to prompt the customer service representative to ensure that all matters have been attended to, and to enter 206 a “call complete” indication. The device 12 thereupon communicates 208 the completion of the service call which is then recorded in the database 113 by the lead management system 30.

It will be appreciated by those skilled in the art that the preferred and alternative embodiments have been described in some detail but that certain modifications may be practiced without departing from the principles of the invention.

1. A quotation service platform for facilitating a product sale and installation quotation sales call, comprising:
a server;
a mobile device in wireless communication with said server; and,
said server comprising instructions that when executed cause the server to accept data from said mobile device, to monitor the progress of said call based on said data, and to collate said data to prepare and serve to said mobile device a display selected from among the group comprising a quotation, a contract, a schedule.

2. The platform of claim 1 wherein said data comprises a plurality of data sets received from said mobile device at different times in the course of said call.

3. The platform of claim 2 wherein said server further comprises instructions that when executed cause the server to retain copies of said data sets and of said display and to serve said display to said mobile device upon request from said mobile device.

4. The platform of claim 2, said mobile device being configured with a plurality of software modules, each of said modules being independently selectable by a graphical user display, said modules comprising at least two modules from the group comprising a quotation module, a contract module and a scheduling module, wherein said quotation module is configured to accept product information that is manually entered on said device and to transmit a request for a quotation to said server, wherein said contract module is configured to accept an indication of acceptance of a quotation that is manually entered on said device and to transmit a request for a contract to said server, and wherein said scheduling module is configured to transmit a request for appointment availabilities in response to a manual request entered on said device.

5. The platform of claim 2, said server further comprising instructions that when executed cause the server to access an availability schedule of product installers.

6. The platform of claim 5, said server further comprising instructions that when executed cause said server, upon receiving from said mobile device a confirmation of an installation appointment, to cause the population of said availability schedule with said appointment.

7. The platform of claim 4 wherein said device comprises a product catalogue stored on said device.

8. The platform of claim 4 wherein said server further comprises instructions that when executed cause said server, in response to a request for a quotation, to retrieve vendor product cost information, to retrieve predetermined service fee rate information, to calculate a quotation based on said vendor product cost information and said service fee rate information, and to deliver said quotation to said device.

9. The platform of claim 8 wherein said instructions further cause said server, in response to said request for a quotation, to communicate with a vendor server to retrieve said vendor product cost information.

10. The platform of claim 8 wherein said instructions further cause said server, in response to said request for a quotation, to verify a quotation for compliance with stored discount policies.

11. The platform of claim 1 wherein said instructions further include instructions that cause said server to authorize credit and to verify a customer identity based on a request received from said device and to deliver an authorization or a refusal of authorization to said device.

12. A method of conducting a product installation sales call, comprising:
a sales representative attending at a customer's premises with a mobile device, said mobile device being in wireless communication with a remote server;
during said call, said representative entering client identification and product identification information on said device, said device transmitting said information to said server;
said server receiving and storing said client identification and said product information;
upon receiving a request for an installation quotation from said device, said server preparing an installation quotation based on data that comprises said client identification and said product information and delivering said installation quotation to said device; and,
upon receiving payment information and a request for a contract from said device, said server preparing a contract based on said installation quotation and delivering said contract to said device.

13. The method of claim 12 wherein said data further comprises vendor product cost information and installation service fee information.

14. The method of claim 13 wherein said step of preparing an installation quotation comprises communicating with a product vendor server and securing said product cost information from said product vendor server.

15. The method of claim 13 wherein said installation service fee information comprises service fee rate information and said step of preparing an installation quotation comprises retrieving said service fee rate information from storage means associated with said server.

16. The method of claim 12 wherein said steps of delivering said installation quotation and delivering said contract comprise delivering images of documents representing said installation quotation and said contract and storing said images in storage means associated with said server.

17. The method of claim 12 further comprising the steps of:
said representative entering payment information on said device;
said customer verifying said payment information; and,
said server processing payment through a credit facility.
